(19) United States
(12) Patent Application Publication
(10) Pub. No.: US 2011/0304467 A1
(43) Pub. Date: Dec. 15, 2011

(54) IMAGE MONITORING DEVICE AND METHOD

(75) Inventor: CHAO-TSUNG FAN, Tu-Cheng (TW)

(73) Assignee: HON HAI PRECISION INDUSTRY CO., LTD., Tu-Cheng (TW)

(21) Appl. No.: 13/043,466

(22) Filed: Mar. 9, 2011

(30) Foreign Application Priority Data
Jun. 14, 2010 (TW) 99119308

(51) Int. Cl. G08B 17/12; H04N 7/18

(52) U.S. Cl. 340/600; 348/135; 348/E07.085

(57) ABSTRACT

In an image monitoring method, a target area is monitored using a computing device connected to an image capture device, a light detection device, and an alarm device. A current image of a target area is acquired using the image capture device, and an illumination intensity of the target area is detected by the light detection device. A standard image of the target area is referenced from a storage system of the computing device according to the illumination intensity and analyzed to detect presence of unwanted activity of the target area. When the unwanted activity is detected, the alarm device is triggered to alarm.

### BACKGROUND

1. Technical Field

Embodiments of the present disclosure relate generally to monitoring methods, and more particularly, to an image monitoring device and method.

2. Description of Related Art

Video monitoring systems may be used to report motion by objects, for example, people or vehicles, to monitor activity in specific locations. However, some such systems may require personnel to monitor display screens, which is an inconvenient and unreliable methodology.

### BRIEF DESCRIPTION OF THE DRAWINGS

FIG. 1 is a block diagram of one embodiment of a computing device including a monitoring system.

FIG. 2 is a block diagram of one embodiment of a target area monitored by the computing device of FIG. 1.

FIG. 3 is a flowchart of one embodiment of an image monitoring method using the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

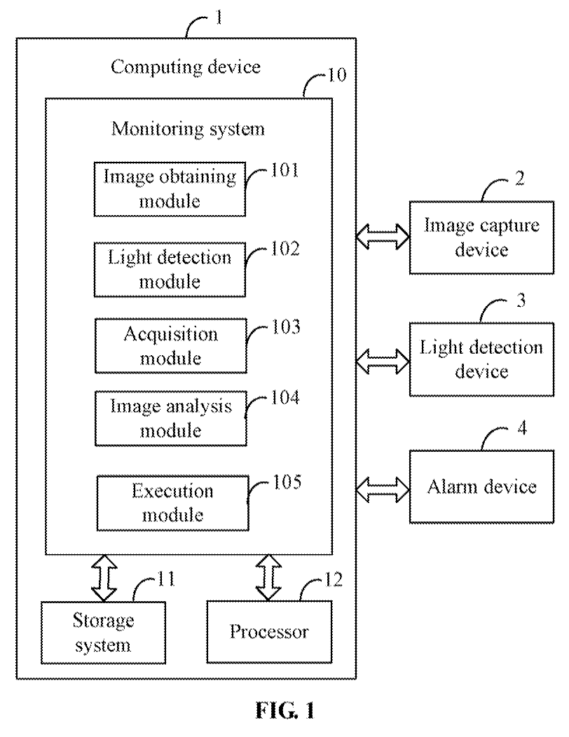

FIG. 1 is a block diagram of one embodiment of a computing device 1 including a monitoring system 10. In the embodiment, the computing device 1 further includes a storage system 11, and a processor 12. The computing device 1 is in electronic communication with an image capture device 2, a light detection device 3, and an alarm device 4 through one or more electrical or wireless connections. In one embodiment, the computing device 1 may be a computer, or a server, for example. It should be apparent that FIG. 1 is only one example of the computing device 1 that can be included with more or fewer components than shown in other embodiments, or a different configuration of the various components.

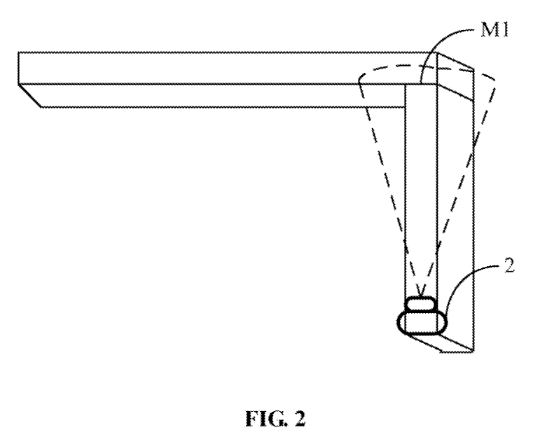

The image capture device 2 captures images of a target area monitored by the computing device 1. As an example, in FIG. 2, the target area is a region around a wall M1, the image capture device 2 may be located on the wall M1 to capture images near the wall M1. In one embodiment, the image capture device 2 may be, for example, a video camera, or a digital camera that can capture images day or night.

The light detection device 3 is installed in the target area to detect an illumination intensity of the target area. The light detection device 3 may be a photometer, for example. The alarm device 4 may be a voice alarm device, or a telephone alarm device, for example. Details of the light detection device 3 and the alarm device 4 follow.

The storage system 11 stores one or more programs, such as programs of an operating system, and other applications of the computing device 1. In one embodiment, the storage system 11 may be random access memory (RAM) for temporary storage of information, and/or a read only memory (ROM) for permanent storage of information. In other embodiments, the storage system 11 may also be an external storage device, such as a hard disk, a storage card, or a data storage medium. The processor 12 executes computerized operations of the computing device 1 and other applications, to provide functions of the computing device 1.

The monitoring system 10 may include a plurality of functional modules comprising one or more computerized instructions that are stored in the storage system 11 or a computer-readable medium of the computing device 1, and executed by the processor 12 to perform operations of the computing device 1. In one embodiment, the monitoring system 10 includes an image obtaining module 101, a light detection module 102, an acquisition module 103, an image analysis module 104, and an execution module 105. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The image obtaining module 101 is operable to obtain a current image of the target area using the image capture device 2. In one embodiment, the image obtaining module 101 may obtain multiple images at regular intervals. For example, the image obtaining module 101 may direct the image capture device 2 to capture images of the target area every two seconds, three seconds, or five seconds.

The light detection module 102 is operable to detect an illumination intensity of the target area using the light detection device 3.

The acquisition module 103 is operable to acquire a standard image of the target area from the storage system 11 according to the illumination intensity. In one embodiment, a group of standard images of the target area based on various illumination intensities are captured by the image capture device 2 in advance, and stored in the storage system 11. For example, if the illumination intensity of the target area is between 400 lumens and 450 lumens, the standard image of the target area based on the illumination intensity is stored as a first standard image. If the illumination intensity of the target area is between 400 lumens and 450 lumens, the standard image of the target area is stored as a second standard image. In the embodiment, the light detection device 3 is equipped to overcome the influence due to the illumination intensity changes of the light, so as to strengthen the reliability of the monitoring system 10.

The image analysis module 104 is operable to compare the current image with the standard image of the target area, and detect presence of unwanted activity of the target area according to the comparison.

In one embodiment, the image analysis module 104 may compare a RGB value of each pixel of the current image with a RGB value of each corresponding pixel of the standard image. The RGB value is consist of a red value, a green value, and a blue value of a pixel. The red value, the green value, and the blue value may be a value of 0 to 255. In the embodiment, if RGB values of some pixels, such as, 15% of all of the pixels of the current image are different from that of the standard image, the unwanted activity, such as, a car is drove into the target area, may be detected. In other embodiments, the image analysis module 104 may analyze the current image of the target area using other image analysis methods, such as an intensity coefficient analysis method, for example.

The execution module 105 is operable to trigger the alarm device 4 to alarm when the unwanted activity is detected. In one embodiment, when the alarm device 4 is triggered, the alarm device 4 may output audio alarms or dial a preset telephone number to inform relevant persons to handle the presence of unwanted activity of the target area. Additionally, the execution module 105 is further operable to display the current image of the target area on a display screen of the computing device 1, so that the relevant persons may know in detail of the target area.

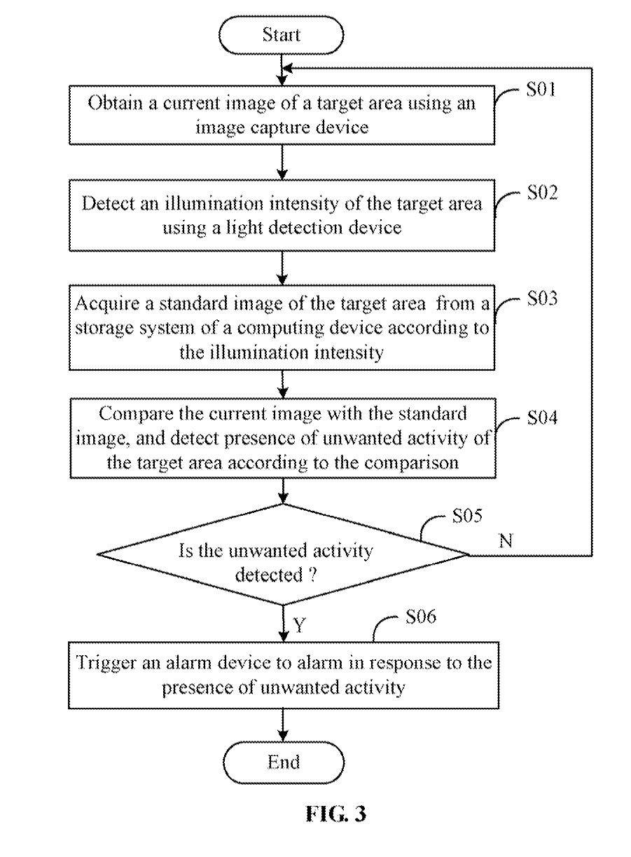

FIG. 3 is a flowchart of one embodiment of an image monitoring method using the computing device of FIG. 1. Depending on the embodiment, additional blocks may be added, others removed, and the ordering of the blocks may be changed.

In block S01, the image obtaining module 101 obtains a current image of a target area using the image capture device 2. In one embodiment, the image obtaining module 101 may obtain the current image of the target area at a regular interval. The target area may be a region around a wall M1 of FIG. 2, for example.

In block S02, the light detection module 102 detects an illumination intensity of the target area using the light detection device 3.

In block S03, the acquisition module 103 acquires a standard image of the target area from the storage system 11 according to the illumination intensity. In one embodiment, a group of standard images of the target area based on various illumination intensities are captured by the image capture device 2 in advance, and stored in the storage system 11.

In block S04, the image analysis module 104 compares the current image with the standard image of the target area, and detects presence of unwanted activity of the target area according to the comparison. In block S05, the image analysis module 104 determines if unwanted activity is detected. If unwanted activity is detected, block S06 is implemented. Otherwise, if no unwanted activity is detected, block S01 is repeated.

In block S06, the execution module 105 triggers the alarm device 4 to alarm in response to the presence of unwanted activity. In one embodiment, when the alarm device 4 is triggered, the alarm device 4 may output audio alarms or dials a preset telephone number to inform relevant persons to handle the presence of unwanted activity of the target area. Additionally, in order to show details of the target area to the relevant persons, the execution module 105 further displays the current image of the target area on a display screen of the computing device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An image monitoring method using a computing device comprising a storage system, the computing device in electronic communication with an image capture device, a light detection device, and an alarm device, the method comprising:
obtaining a current image of a target area using the image capture device;
detecting an illumination intensity of the target area using the light detection device;
acquiring a standard image of the target area from the storage system according to the illumination intensity;
comparing the current image with the standard image of the target area, and detecting presence of unwanted activity of the target area according to the comparison;
triggering the alarm device to alarm when the unwanted activity is detected.

2. The method according to claim 1, wherein the comparison of the current image and the standard image of the target area is by comparing a RGB value of each pixel of the current image with a RGB value of each corresponding pixel of the standard image.

3. The method according to claim 1, wherein the storage system stores a group of standard images of the target area based on various illumination intensities of the target area captured by the image capture device in advance.

4. The method according to claim 1, further comprising:
displaying the current image on a display screen of the computing device when the unwanted activity is detected.

5. The method according to claim 1, wherein the alarm device is a voice alarm device or a telephone alarm device.

6. The method according to claim 1, wherein the alarm device outputs audio alarms or dials a preset telephone number to inform relevant persons to handle the presence of unwanted activity.

7. A computing device in electronic communication with an image capture device, a light detection device, and an alarm device, the computing device comprising:
at least one processor;
a storage system; and
one or more programs stored in the storage system and being executable by the at least one processor, the one or more programs comprising:
an image obtaining module operable to obtain a current image of a target area using the image capture device;
a light detection module operable to detect an illumination intensity of the target area using the light detection device;
an acquisition module operable to acquire a standard image of the target area from the storage system according to the illumination intensity;
an image analysis module operable to compare the current image with the standard image of the target area, and detect presence of unwanted activity of the target area according to the comparison;
an execution module operable to trigger the alarm device to alarm when the unwanted activity is detected.

8. The computing device according to claim 7, wherein the comparison of the current image and the standard image of the target area is by comparing a RGB value of each pixel of the current image with a RGB value of each corresponding pixel of the standard image.

9. The computing device according to claim 7, wherein the storage system stores a group of standard images of the target area based on various illumination intensities of the target area captured by the image capture device in advance.

10. The computing device according to claim 7, wherein the execution module is further operable to display the current image on a display screen of the computing device when the unwanted activity is detected.

11. The computing device according to claim 7, wherein the alarm device is a voice alarm device or a telephone alarm device.

12. The computing device according to claim 7, wherein the alarm device outputs audio alarms or dials a preset telephone number to inform relevant persons to handle the presence of unwanted activity.

13. A non-transitory storage medium storing a set of instructions, the set of instructions capable of being executed by a processor of a computing device to perform an image monitoring method, the computing device in electronic communication with an image capture device, a light detection device, and an alarm device, the method comprising:
obtaining a current image of a target area using the image capture device;
detecting an illumination intensity of the target area using the light detection device;
acquiring a standard image of the target area from a storage system of the computing device according to the illumination intensity;
comparing the current image with the standard image of the target area, and detecting presence of unwanted activity of the target area according to the comparison;
triggering the alarm device to alarm when the unwanted activity is detected.

14. The storage medium as claimed in claim 13, wherein the comparison of the current image and the standard image of the target area is by comparing a RGB value of each pixel of the current image with a RGB value of each corresponding pixel of the standard image.

15. The storage medium as claimed in claim 13, wherein the storage system stores a group of standard images of the target area based on various illumination intensities of the target area captured by the image capture device in advance.

16. The storage medium as claimed in claim 13, wherein the method further comprises:
displaying the current image on a display screen of the computing device when the unwanted activity is detected.

17. The storage medium as claimed in claim 13, wherein the alarm device is a voice alarm device or a telephone alarm device.

18. The storage medium as claimed in claim 13, wherein the alarm device outputs audio alarms or dials a preset telephone number to inform relevant persons to handle the presence of unwanted activity.
